(19) United States
(12) Patent Application Publication
(10) Pub. No.: US 2022/0237616 A1
(43) Pub. Date: Jul. 28, 2022

(54) SYSTEMS AND METHODS FOR IMPROVED BILL PAYMENT

(71) Applicant: Proactive Fintech LLC, Pleasant Grove, UT (US)

(72) Inventor: Ryan J. Clark, Cedar Hills, UT (US)

(21) Appl. No.: 17/586,768

(22) Filed: Jan. 27, 2022

Related U.S. Application Data
(60) Provisional application No. 63/142,448, filed on Jan. 27, 2021.

(51) Int. Cl. G06Q 20/40; G06Q 20/02; G06Q 20/10

(52) U.S. Cl. CPC G06Q 20/405; G06Q 20/102; G06Q 20/023

(57) ABSTRACT

Systems and methods for improved bill payment. In some embodiments, the system may allow users to precisely track and approve/deny incoming and/or outgoing transactions using rules, some of which may be preset by the system and others of which may be set and changed as desired by the users. Rules may allow for restricting approved transactions, for example, to a particular merchant or group of merchants, a particular amount or range/threshold amount(s), dates, or time frames.

### CROSS-REFERENCE TO RELATED APPLICATIONS

This application claims the benefit of U.S. Provisional Patent Application No. 63/142,448, filed Jan. 27, 2021, and titled “SYSTEMS AND METHODS FOR IMPROVED BILL PAYMENT,” which is hereby incorporated herein by reference in its entirety.

### SUMMARY

Systems and methods are disclosed herein that relate to payment of bills and other transaction payments. For example, the inventive concepts disclosed herein may be used to provide systems and/or methods to allow users to pre-authorize specific transactions before the transactions take place and/or remove authorization for certain transactions, or any transactions that have not been previously authorized, including in some cases both one-time purchases and recurring transactions, such as transactions resulting from recurring bills or subscriptions. Some embodiments may allow for control of both incoming and outgoing transactions.

In preferred embodiments, the inventive systems and/or methods may allow users to establish an account with a system operable on, for example, a mobile application. The user may then be able to create a series of rules to pre-authorize specific transactions to ensure precise control over bill payments. This may allow a user to avoid situations in which unknown charges hit their account, which results in lost time spent investigating and/or disputing charges. The system may be set up, or allow a user to select an option, to decline any and all transactions that have not been pre-approved. This can put the user in complete control of their bill payment spending from any payment method, including check, ACH, and card payments. The system may also allow a user to pre-authorize both one-time payments and recurring bills/subscriptions.

In some embodiments, transaction attempts may be recognized and/or matched based on, for example, card PAN numbers, merchant names or ID numbers, transaction dates or time frames, and/or amounts, including specific amounts or, alternatively, amount thresholds or ranges. Some embodiments may also allow users to initiate traditional bill payment options as well, if desired. Various systems and methods disclosed herein may therefore allow for more efficient and proactive completion of debt elimination plans.

In a more specific example of a method for automated bill payment, the method may comprise receiving bill data regarding a first user of a bill payment system, which bill data may be entered on a mobile application or a web-based application under control of the first user, or may be received from a merchant of the first user. The bill data may comprise at least sufficient data to identify an anticipated bill.

A bill authorization data record may be created from the bill data, which bill authorization data record may comprise data sufficient to accept or reject requested transactions. A transaction attempt may then be received from a merchant comprising at least one of a requested ACH transfer and a requested debit card transaction. Data from the transaction attempt may then be compared with data from the bill authorization data record and the transaction attempt may be selectively accepted or rejected based upon the comparison of data from the transaction attempt with data from the bill authorization data record. Upon determining that transaction attempt should be accepted, funds may be automatically transferred from an account of the first user in the bill payment system to complete the transaction requested in the transaction attempt.

In some implementations, the bill data comprises merchant identifying information, such as merchant names, partial merchant names, or other merchant identifying information, such as ID numbers or MCC numbers.

In some implementations, the bill data may further comprise various rules/parameters for selectively accepting or rejecting incoming bill payment requests, such as an authorized transaction amount, an authorized transaction amount range, an authorized date, and/or an authorized date range.

Some implementations may further comprise receiving bill data for each of a plurality of accounts, such as sub and/or virtual accounts each linked with the same user. For example, in some such implementations, each of the plurality of accounts may be associated with a distinct merchant. Some accounts, however, may be associated with a category of merchants or types of bills, such as utilities.

In some implementations, any and all transaction attempts that fail to match preconfigured parameters/rules established within a bill authorization data record may be declined, such that the user has total control over spending in, for example, various sub-accounts linked with his account in a bill payment system.

Some implementations may further comprise receiving an outgoing bill payment request to transfer funds from the first user of the bill payment system to a second user of the bill payment system. The outgoing bill payment request may comprise, for example, an amount and/or a recurring time period for automated, repeated payment of the amount.

Some implementations may further comprise receiving an indication from the user as to whether the transaction attempt was properly accepted or rejected and, upon receiving an indication from the user that the transaction attempt was properly accepted, saving merchant identification data associated with the accepted transaction, such as an MCC code. The updated merchant identification data may then be used to facilitate expedited authorization of a subsequent transaction from the same merchant, such as by more precisely matching data from future requests.

Some implementations may further comprise receiving a transaction attempt from one or more merchants comprising a requested ACH transfer and a transaction attempt from one or more other merchants comprising a requested debit card transaction, both of which may be processed by comparing with rules/parameters and selectively accepting/rejecting them, and automatically transferring funds for the accepted requests.

In another specific example of a method for automated bill payment according to some implementations, the method may comprise receiving a set of bill payment rules from a first user of a bill payment system from a mobile application or a web-based application under control of the first user, and receiving a first bill payment request from a first merchant for payment of a first bill by the first user, wherein the first bill payment request comprises an ACH transfer request.

Data from the first bill payment request may be compared with the set of bill payment rules, and the first bill payment request may be selectively accepted or rejected according to whether the first bill payment request contains data matching parameters established by the set of bill payment rules.

A second bill payment request may be received from a second merchant for payment of a second bill by the first user, wherein the second bill payment request comprises a requested debit card transaction. Thus, the bill payment system may be configured to handle both ACH and debit card transactions, in some cases along with requested internal bill payments between users of the system.

Data from the second bill payment request may be compared with the set of bill payment rules and the second bill payment request may be selectively accepted or rejecting according to whether the second bill payment request contains data matching parameters established by the set of bill payment rules.

Some implementations may further comprise, upon accepting the first bill payment request, saving data from the first bill payment request and linking the saved data from the first bill payment request with an account of the first user.

Some implementations may comprise receiving a third bill payment request from the first merchant for payment of a third bill by the first user and accessing the saved data from the first bill payment request to facilitate faster approval of the third bill payment request.

The set of bill payment rules may comprise, for example, a merchant name, a merchant ID number, a transaction amount, a transaction amount range, a transaction amount threshold, a transaction date, and/or a transaction date range.

In some implementations, a separate set of bill payment rules may be established for each sub-account of a plurality of sub-accounts of the first user, which may allow each incoming transaction associated with the first user to be matched, or at least attempted to be matched, with all of the various sub-accounts of the first user.

Some implementations may further comprise, upon determining that the first bill payment request should be rejected, sending an inquiry to the first user regarding whether the rejection of the first bill payment request was handled properly. A response may be received and processed from the first user to the inquiry. For example, upon receiving a response to the inquiry that the first bill payment was handled incorrectly, the set of bill payment rules may be updated in a manner such that future bill payment requests matching the first bill payment request will be accepted. Similarly, if the first bill payment request was wrongly accepted, the system may be configured to ensure that similar bill payment requests in the future will be rejected such as, for example, by applying a new rule or increasing the stringency of the previous rules in a manner that would have resulted in the first bill payment request being initially rejected.

In a specific example of a system for automated bill payment according to some embodiments, the system may comprise one or more processors; a computer readable memory operably coupled with the one or more processors; and one or more functional modules that may be configured to apply various bill payment processing rules. For example, a bill payment rules module may be configured to receive bill authorization data from a mobile application or a web-based application under control of a first user of the system for automated bill payment and/or from a merchant requesting payment of a bill by the first user.

The system may further comprise a bill payment authorization module configured to receive a bill payment request from a merchant for payment of a bill by the first user. The bill payment authorization module may be configured to compare data acquired by the bill payment rules module with data from the bill payment request to selectively approve or deny the bill payment request.

In some embodiments, the system may be configured to receive and selectively accept or reject bill payment requests as either ACH transfer requests or debit card transaction requests. Some embodiments may further be configured to receive and selectively accept or reject internal bill payment requests from other users of the system, rather than external vendors.

In some embodiments, the bill payment rules module may be configured to establish and link a separate set of rules with each of a plurality of sub-accounts associated with the first user.

Some embodiments may be configured to compare incoming bill payment requests with data associated with previous transactions associated with the first user and revise further processing of incoming bill payment requests depending upon whether a match with a previous transaction associated with the first user is identified. For example, in some embodiments, the system may be configured to, upon determining that a merchant associated with an incoming bill payment request fails to sufficiently match a previous transaction, and following approval of the incoming bill payment request, send an inquiry to a user to confirm whether the approval was handled appropriately and, upon confirmation that the approval was handled appropriately, save transaction data from the incoming bill payment request to be used to streamline future processing of bill payment requests from the same merchant.

The features, structures, steps, or characteristics disclosed herein in connection with one embodiment may be combined in any suitable manner in one or more alternative embodiments.

### BRIEF DESCRIPTION OF THE DRAWINGS

Non-limiting and non-exhaustive embodiments of the disclosure are described, including various embodiments of the disclosure with reference to the figures, in which:

FIG. 1 is a schematic diagram illustrating an example of a system for improved bill payment according to some embodiments;

FIG. 2 is a flow chart illustrating an example of a method for collection of data to establish an improved bill payment system according to some implementations;

FIG. 3 is a flow chart illustrating an example of a method for improving the payment of an outgoing bill payment transaction according to some implementations;

FIG. 4 is a flow chart illustrating an example of a method for improving the payment of an incoming bill payment transaction according to some implementations;

FIG. 5 is a flow chart illustrating a portion of a method for improving bill payment comprising assessing a first-time incoming transaction and pulling data or correcting the handling of the transaction according to some implementations;

FIG. 6 is a flow chart illustrating an alternative structure for a portion of the processing of a repeat transaction according to some implementations; and

FIG. 7 is a flow chart illustrating another sub-process that may be a part of method for improved bill payment in some implementations.

### DETAILED DESCRIPTION

A detailed description of apparatus, systems, and methods consistent with various embodiments of the present disclosure is provided below. While several embodiments are described, it should be understood that the disclosure is not limited to any of the specific embodiments disclosed, but instead encompasses numerous alternatives, modifications, and equivalents. In addition, while numerous specific details are set forth in the following description in order to provide a thorough understanding of the embodiments disclosed herein, some embodiments can be practiced without some or all of these details. Moreover, for the purpose of clarity, certain technical material that is known in the related art has not been described in detail in order to avoid unnecessarily obscuring the disclosure.

The embodiments of the disclosure may be best understood by reference to the drawings, wherein like parts may be designated by like numerals. It will be readily understood that the components of the disclosed embodiments, as generally described and illustrated in the figures herein, could be arranged and designed in a wide variety of different configurations. Thus, the following detailed description of the embodiments of the apparatus and methods of the disclosure is not intended to limit the scope of the disclosure, as claimed, but is merely representative of possible embodiments of the disclosure. In addition, the steps of a method do not necessarily need to be executed in any specific order, or even sequentially, nor need the steps be executed only once, unless otherwise specified. Additional details regarding certain preferred embodiments and implementations will now be described in greater detail with reference to the accompanying drawings.

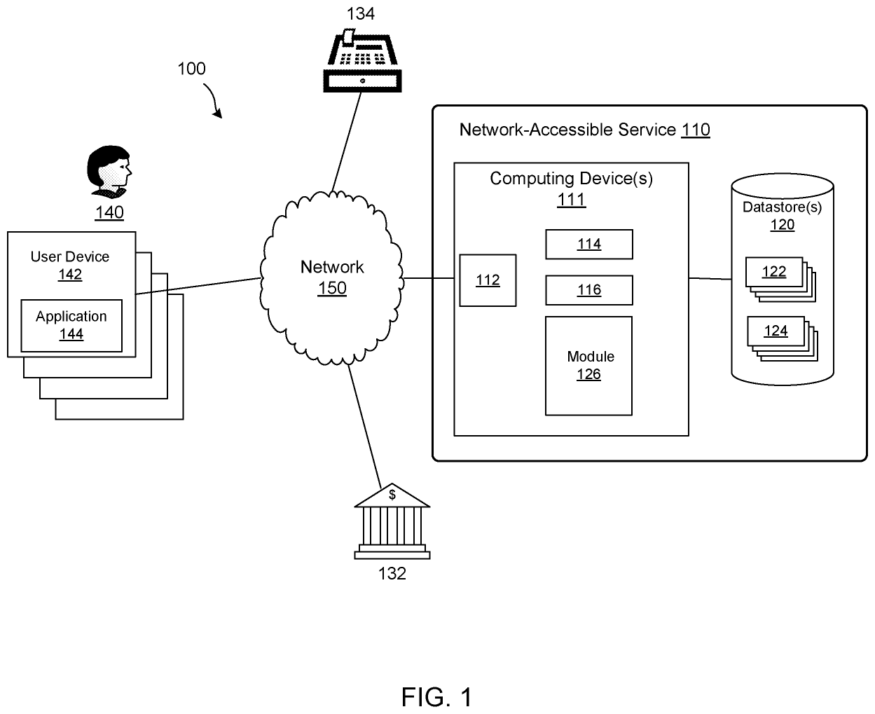

FIG. 1 depicts an example of a system 100 for facilitating improved payment of bills and/or other transactions according to some embodiments. As shown in this figure, one or more client or devices, such as client devices 142, may be configured to communicate with one or more computing devices over a network 150. In the depicted embodiment, users 140 may each operate an application 144, such as a mobile application operating on a smartphone or other user device 142, for example. Client devices 142 may communicate through network 150 network-accessible service 110, which may comprise various computers or other computing devices 111 (e.g., server computers). The computing device 111 may comprise a communication interface 112, one or more processors 114, and memory 116. The computing device 111 may comprise and/or be communicatively coupled to a datastore 120. The datastore 120 may be implemented using a database, directory, or other persistent data storage mechanism. Accordingly, the datastore 120 may comprise a non-transitory machine-readable storage medium, such as a hard disk, solid state memory, or other non-volatile memory. One or more operational modules 126 may be configured to cause processor 114 to take various steps in accordance with one or more aspects of various embodiments of the invention disclosed herein. Of course, operational modules may also be present on each user device 142 and may be part of application 144.

The datastore 120 may store user account information in user account records 122 for users 140 of the system 100. Each user account record 122 may include user profile information, such as a username, contact information (e.g., email address, telephone number, etc.), account balances, etc. Additional information may be stored in a set of user rules or preferences 124, which may comprise, for example, preauthorized transactions and/or blocked transactions, including data associated with such transactions, such as authorized (or non-authorized) merchants, specific amounts for authorized transactions or ranges and/or limits for authorized transactions, expected times or time frames for authorized transactions, preferred or authorized payment methods, and the like. In some embodiments, user preferences/rules 124 may be stored in user account records 122 if desired.

In some embodiments, computers and/or systems of one or more banks or other financial institutions 132 may be coupled via network 150 to network-accessible service 110. For example, each of the users 140 may have a bank account or an account at another financial institution that may be used to fund accounts created through application 144, which, again, may comprise a mobile application running on a smartphone, a Web-based application, or the like. Client devices 142 may therefore comprise any computing device suitable for implementing the inventive systems and/or methods described herein and preferably comprising a processor, including but not limited to a personal computer, a laptop computer, a desktop computer, a notebook or tablet, a smartphone, and the like.

One or more merchants 134 may also be coupled via network 150 to application 144 and/or network-accessible service 110. As described in greater detail below, for example, merchants 134 may issue bills or invoices to a user 140. User 140 may then establish various rules or parameters that allow the user to take control of bill payments more effectively and proactively by, for example, pre-authorizing certain transactions. Pre-authorization parameters may include, for example, merchant names or other merchant identification information, specific authorized amounts or amount ranges, and/or times or time frames for expected transactions. The user may be allowed to block any and all transactions that fail to meet these rules/parameters, which may allow consumers to avoid various unwanted transactions, such as fraudulent transactions, transactions for subscriptions that are no longer wanted, or transactions for more than an expected amount, thereby allowing greater control of bill payment than is provided by existing solutions. Some embodiments may also allow a user to easily track bills or other transactions and compile them for purposes of budgeting, accounting, spending control, and the like.

In some embodiments, users may even be allowed to precisely limit the number and/or amount of transactions, including the total amount of one's bills, each month without worrying about unexpected transactions. This may allow for incorporation of system 100 with a debt elimination plan or system. For example, by facilitating precise control over all spending—including not just individual transactions that the user may enter on an individual basis but subscriptions, other recurring transactions, and any other bill payment or other payment transactions, including card, ACH, and check payments—a user may be able to precisely control all spending in accordance with a particular debt elimination plan, which may but need not also be part of system 100.

In some embodiments, system 100 may work in connection with a budgeting system that requires pre-funding of specific accounts, sub-accounts, and/or virtual accounts, prior to spending. Thus, a user may be forced to contemplate each purchase before it is made by, for example, requiring that a particular account in a particular spending category, such as “entertainment,” be funded by inputting the amount and/or account/category before each transaction. By coupling these features with a system configured to allow a user to pre-authorize each bill payment, including recurring bills, users can take full control over their finances and can more proactively and impactfully budget, eliminate debt, and view and account for each area of spending and spending as a whole.

Thus, in some embodiments, a virtual or sub-account may be set up for each merchant/vendor, or more broadly for categories of bills such as “utilities” or “home improvement.” These virtual or sub-accounts may be specific to bill payment and, unless properly pre-funded or pre-configured with sufficient data and/or rules to allow for evaluating incoming bill payment requests, may be configured to reject any and all incoming payment requests, which may put the user in total control of their spending.

Communication between the client device(s) and the server(s) may take place over a network 150, which may comprise, for example, the Internet, a local area network, a virtual private network, a mobile network, and/or any other communication network utilizing one or more electronic communication technologies and/or standards (e.g., Ethernet or the like). Information pertaining to the system 100 may be presented to various clients/users in an application 144 operating on a client/user device 142. This application may comprise, for example, a general-purpose web browser application, a special-purpose application, such as a mobile phone application, or the like.

Each client/user device 142 and/or computing device/server 111 may comprise various modules, elements, or other functional sub-parts configured to implement various aspects of certain embodiments of the invention as desired.

In some embodiments, authentication steps may take place and/or be provided between network-accessible service 110 and one or more user devices 142. Authentication may take place by any means known or otherwise available to one of ordinary skill in the art, such as by use of passwords, a digital signature, biometrics, or other credentials provided by users.

As previously mentioned, each user 144 may download or otherwise use an application, such as a mobile app on a computing device, such as a computer or mobile smartphone, and may be issued an account on a system accessible via the application. In some embodiments, each user may also be issued a debit card or another payment means, which may allow for funding and/or sharing various virtual/sub-accounts between users, either using their own cards or another means for payment, such as using the card number without a physical card. This may allow system 100 to be used for collaborative money management, such as jointly funding and/or spending from a shared account, establishing various virtual or sub-accounts for spending within a particular category, splitting costs of a transaction with other users of the system, or repayment of funds between users following a transaction. Further details regarding other aspects of system 100 can be found in U.S. patent application Ser. No. 17/524,678, which is titled “SYSTEMS AND METHODS FOR COLLABORATIVE MONEY MANAGEMENT,” and which was filed on Nov. 11, 2021, the entire contents of which are hereby incorporated herein by specific reference.

It should be understood that, although debit cards may be issued to each user 144 in preferred embodiments, in alternative embodiments, other means for payment may be issued to one or both of the users, either in addition to a card or in lieu of a card. Examples of such alternative means for payment include mobile wallets or other mobile payment systems, other cards, and the like. Any form of payment that can be linked with an account holder and used to effectuate payment during a transaction, such as a transaction at a point of sale or a transaction over the Internet for example, should be considered within the scope of the present disclosure.

Users and/or accounts of various users of system 100 may be linked, either temporarily or permanently, with an account at a bank or other financial institution. In alternative embodiments and implementations, however, it is contemplated that the accounts used by system 100 may be financial institution accounts or may be operated by a financial institution, in which case the financial institution may operate, wholly or in part, system 100 and thus a link to an independent financial institution may not be required.

Users 140 and of user accounts may have a plurality of virtual or sub-accounts associated with their respective accounts. Each of the virtual and/or sub-accounts may have a spending category associated with it and/or an amount. The spending categories of each virtual/sub-account may be preassigned, assigned by the user, or may comprise a combination of pre-assigned categories and user-assigned categories. Examples of spending categories include vacation, food, clothing, mortgage/rent, utilities, recreation, etc. An amount may also be associated with each virtual/sub-account, which amount may indicate a limit to which the user may spend within the virtual/sub-account during a predefined time period, such as per month. In some cases, the spending amount may lack a predefined time period, however. For example, a user may set up a virtual/sub-account for a particular event, such as an upcoming vacation, that, once depleted, will not be renewed.

In addition, separate accounts, sub-accounts, and/or virtual accounts may be set up for each merchant and/or bill, such as a merchant that will be expected to issue recurring charges. Thus, as described in greater detail below, a user may input data and/or system 100 may be configured to gather data that allows for identification of a particular charge expected from a particular merchant or simply for a particular merchant without regard for the amount. These accounts and their corresponding data may be used to assess each charge that hits an account, either by way of ACH, card transactions, or more traditional check transactions, and either accept or reject them based upon the data and accompanying rules that the user may set up.

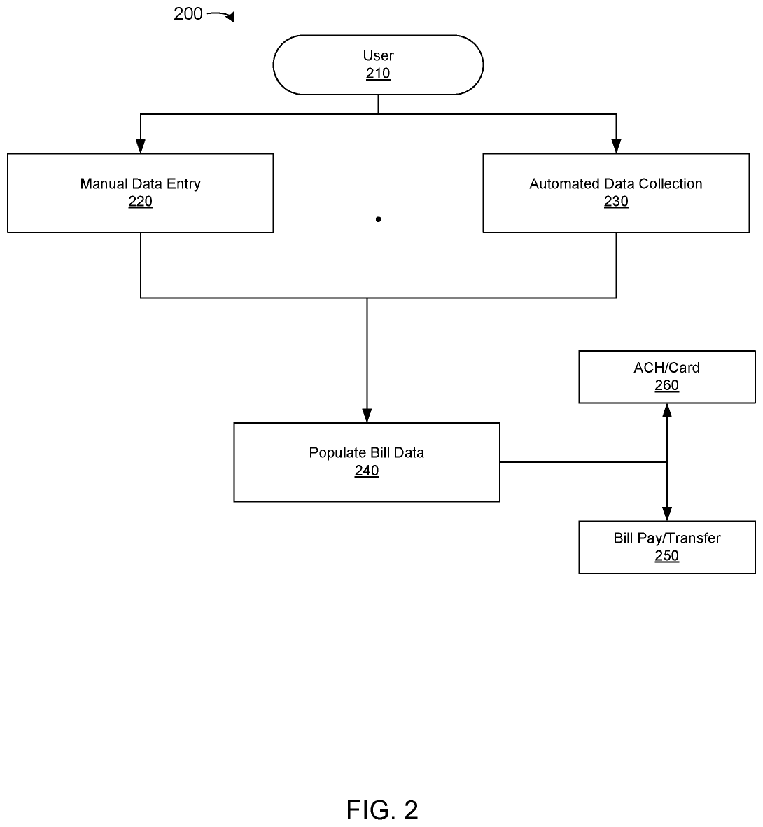

FIG. 2 is a flow chart illustrating an early stage of a method 200 that may be part of a broader method or process involving system 100. Steps of the method 200, and any of the other methods shown in other figures or otherwise described herein, may be implemented using machine-readable instructions stored on a non-transitory, machine-readable media (e.g., hard disk, non-volatile memory, etc.), such as machine-readable instructions stored within a mobile smartphone, tablet, or other computing device. One or more of these steps may therefore comprise loading one or more machine-readable instructions for execution by a processor of the smartphone/computing device. Steps of method 200 and/or other methods described herein may be tied to particular machine components, such as computing resources (e.g., a processor, memory, etc.), data storage resources (e.g., database, datastore, etc.), communications interfaces (e.g., network interfaces), human-machine interface components, and the like. Accordingly, various process steps may comprise allocating and/or initializing machine components.

As shown in FIG. 2, user 210 may decide to authorize a particular transaction or set of transactions. Data for establishment of this authorization, which may include rules and/or data used to filter and/or identify incoming transactions may be collected by manual data entry at 220, by use of a data aggregator or another automated data collection means 230, or both.

At step 220, user 210 may be prompted to enter and/or may enter various pieces of data relating to a particular bill or other transaction, or group of bills or other transactions. Such data may include, for example, merchant names or other merchant identifying information, such as an identification number, an expected transaction amount, a threshold amount for authorized transactions from a particular merchant or group of merchants, and/or a range of authorized amounts, a particular date and/or time for the anticipated/authorized transaction, and/or a time frame/range for the anticipated/authorized transaction.

Alternatively, system 100 may allow user 210 to use an automated means for obtaining information to identify an authorized transaction or series of transactions, such as aggregator, at 230. In some embodiments and implementations, an aggregator or another automated data entry means 230 may provide a link to an external source that will allow for automated retrieval of sufficient data for this identification. For example, a link may be provided to allow user 210 to log in to a merchant website. Upon receiving confirmation of a successful login, system 100 may be configured to extract data sufficient to identify the merchant for purposes of accepting or rejecting future transaction attempts.

Of course, in some embodiments and implementations, both sides of method 200 may be used. In other words, user 210 may manually enter some data at 220, such as preconfigured rules for acceptance of incoming transactions, and may have other data entered via an aggregator or another automated method 230, which may provide data sufficient to identify an authorized merchant and/or details regarding the amount of the transaction to supplement the data/rules created by user 210.

Data from steps 220 and/or 230 may then be populated at 240 to create a bill authorization data record. Again, the data used to create/populate this data record may be solely entered/received by user 210, solely auto-populated by accessing, for example, an external link containing merchant information and/or other details about a bill payment to be authorized, and/or created from both sources.

Method 200 may then split into two paths depending upon where the proposed bill for authorization by user 210 originates. For example, this split may be determined based on whether the transaction will be an incoming transaction or an outgoing transaction. If the bill is to be paid via an outgoing transaction, such as a money transfer or bill pay feature for example, method 200 may proceed to step 250, whereas if the bill is to be paid via an incoming transaction, such as an ACH transfer or card, for example, method 200 may proceed to step 260.

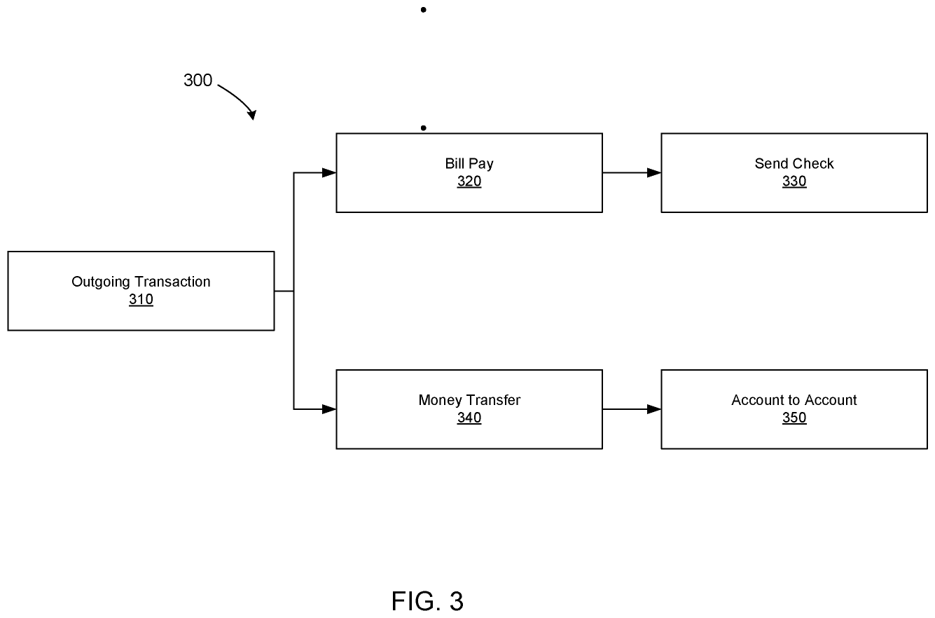

FIG. 3 illustrates a sub-process 300 that may be a part of method 200 in some implementations. Sub-process 300 may be triggered by, for example, an indication that the bill payment originated with a user and/or is to result in payment via a bill pay and/or money transfer process from within system 100 (an outgoing transaction) as opposed to a transaction that is attempted by a merchant from outside of system 100 (an incoming transaction). In this case, the system may use one or more triggers to initiate an outgoing transaction at 310. This trigger may, for example, consist of a user selecting a bill pay 320 or money transfer 340 option from within a mobile or web-based software application.

In preferred embodiments, the user may be able to initiate the transaction as a recurring transaction that will take place, for example, monthly, or on any other schedule as selected by the user. Thus, for example, a user may decide to authorize a weekly payment to a merchant for piano lessons. After inputting sufficient data to identify the vendor and the amount of the weekly charge, the system may automatically render payment for the authorized amount on the authorized schedule. If the second user is also part of system 100, then the recurring payment may take place by simply transferring funds from the originating user's account, or a sub-account with a particular spending category, to that of the payee's account at 350. This may be accomplished using one or more of the accounts and/or teachings of U.S. Provisional Patent Application No. 63/112,507 titled “SYSTEMS AND METHODS FOR COLLABORATIVE MONEY MANAGEMENT” and filed on Nov. 11, 2020, which, as previously mentioned, is incorporated herein by reference.

If, on the other hand, the payee/merchant is not part of system 100, then system 100 may be configured to automatically issue weekly (or on whatever other schedule the paying user may dictate) checks or ACH payments to the vendor at 330.

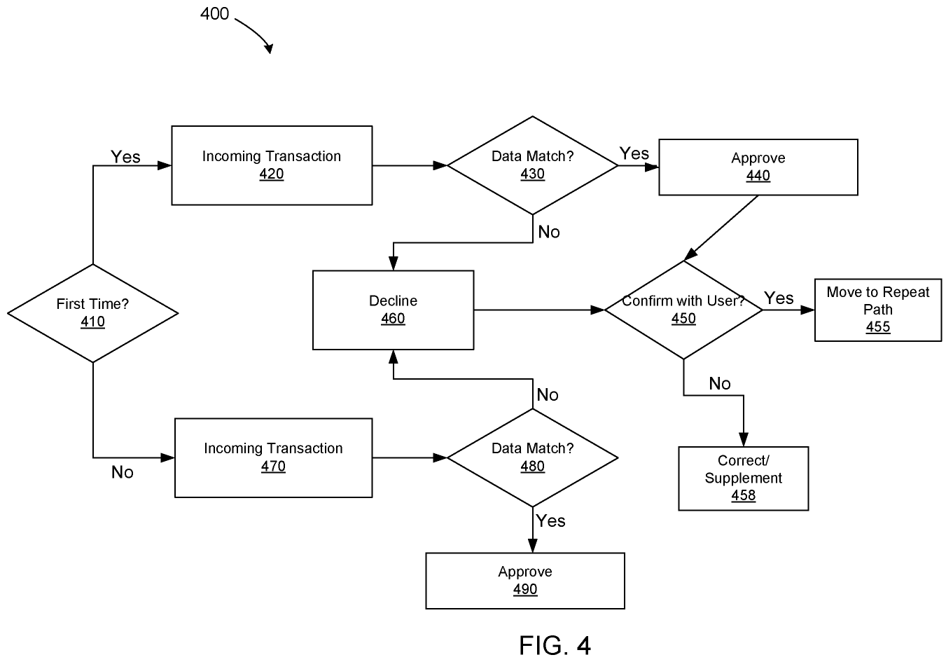

FIG. 4 illustrates another sub-process 400 that may also be a part of method 200 in some implementations. Sub-process 400 may be triggered by, for example, an indication that the bill payment originated outside of system 100, such as from an external merchant, and/or is to result in payment via ACH or card. Thus, sub-process 400 may follow from step 250 in FIG. 2, for example. At 410, an inquiry/analysis may be performed to determine whether this is the first transaction from the vendor/merchant. For example, if a previous transaction was successfully processed from the same merchant, step 410 may comprise matching data entered/obtained at, for example, steps 220 and/or 230, with data stored from a previous transaction, which may allow the system to determine whether this is a known vendor.

In some embodiments and implementations, data used to make the determination in step 410 may be compiled from when a user creates an initial account, or an initial sub and/or virtual account associated with a particular transaction, and its associated rules for the first time. This data may then be used to match/route an incoming transaction's data with a particular account or sub-account, such as, for example, matching an approved transaction amount. With this association and the user's approval, transaction data, such as the merchant's name, date, merchant category code (MCC), and/or the like may be saved to be used for future matching.

If the vendor cannot be identified/matched with previous data, then process 400 proceeds to step 420 to receive data from an incoming transaction attempt. Data from the incoming transaction 420 may then be compared with data used to authorize a transaction—which, again, may comprise data entered/obtained at, for example, steps 220 and/or 230—with data from the incoming transaction attempt at step 430. For example, in a simple case, a user may have entered an exact transaction amount, or a threshold or range, that is to be authorized. Step 430 may then comprise attempting to match this authorization data with a requested transaction amount from the incoming transaction. If the data sufficiently matches, the transaction is approved at step 440. If the data fails the matching test, the transaction may be declined at step 460.

Although transaction amounts may be useful to attempt a match at step 430, such data may be omitted in favor of other types of data, or used in conjunction with other types of data, to attempt this match. Thus, as another example, a user may input data, such as a merchant/vendor name, other merchant-identifying information, such as a merchant ID number, and/or a date/time or date range for the transaction. Such data may be used, either alone or in conjunction with transaction amount-identifying data (either exact or a threshold, such as a maximum charge amount, or a transaction range), to attempt to match an incoming transaction attempt at step 430.

Again, in some embodiments, users may be given the ability to make transaction matching as rigid or flexible as they desire. For example, a user may wish to have all incoming transactions that do not precisely match an expected amount denied. Alternatively, due to taxes or an inability to assess the expected incoming transaction amount exactly, a user may wish instead to provide a range of authorized amounts or a threshold for authorized amounts. Similarly, a user may wish to authorize an expected transaction if a minimal matching of characters or other merchant identifying data takes place or may wish to make matching more rigid to prevent unwanted transactions by insisting on a more precise match, either with or without accompanying transaction amount or amount range/threshold matching.

Some embodiments may also categorize bills/transactions, or allow a user to categorize bills/transactions, so that some require more rigid matching than others. For example, a “utilities” category may be established that may have more relaxed matching stringency than other categories, which may account for the variability in monthly charges resulting from, for example, power or water usage, to avoid issues of non-payment due to relatively minor differences in monthly bills.

In some embodiments, the range for certain categories may be preselected by the system. For example, a utilities category may be configured to allow for variability of ±10% or 20%. Of course, this amount, whether based on a percentage or a precise amount or precise range, may be changed by the user as desired in certain embodiments.

Other categories may be established, either as a pre-configured category or an optional category by the user, that may require more rigidity in matching. For example, a category for Amazon.com or another online retailer may be established the transactions for which are expected to widely vary and not necessarily follow a particular schedule. Such transactions or categories of transactions may require a precise match, or at least a more precise match, such as ±5% of an expected amount, for example.

Similar ranges for other parameters, such as date ranges, may also be preconfigured, selectable by the user, or preconfigured with a default setting but changeable by the user. For example, bills that are expected on the 15th of each month may only be processed if invoiced on the 15th, or may be given some leeway, such as ±2 days, if desired.

Following approval of the transaction, the user may be given the option to confirm that the transaction authorization was correct and make changes to the system to account for any incorrect authorizations. If the incoming transaction is confirmed by the user at 450, since this is the first transaction of this type (such as the first transaction from this merchant/vendor, for example), the process may then proceed to step 455, at which point the user may confirm that the transaction was handled as desired. If so, transactions of the same type—such as transactions from the same vendor or, if transactions from the same vendor are expected to vary, such as transactions from an online retailer, then transactions matching in other ways, such as amount, date, etc., either alone or in conjunction with a matching vendor—may be flagged for handling under the “no” or “repeat” path from step 410 in the future.

If the transaction was not handled according to the user's preferences, then the process may proceed to step 458, at which point the errors/discrepancies between the processing of the transaction and the user's preferences may be corrected and/or additional information may be requested for future processing of transactions from the same vendor and/or otherwise of the same type. In some embodiments and implementations, this may result in placement of such transactions back on the upper path from step 410 or may result in receipt of additional information before the transaction/transaction type can be treated as a confirmed repeat. For example, if the user desires that future transactions of the type approved, be denied in the future, the user may choose to block transactions from the particular vendor, or transactions otherwise matching parameters of the problematic transaction.

If, on the other hand, the transaction is one that the user authorizes but wishes to change the parameters of for future approval, other changes can be made at step 458, or the user can simply choose to indicate a problem with the transaction that will route future transactions of the same type to the “first time” path.

Although step 450 is shown following the approval or declination in steps 440 or 460, it is contemplated that, in other embodiments and implementations, a user may be given the opportunity to confirm an incoming transaction, or at least certain types of transactions, before it is approved. This, the confirmation step may precede the approval/declination steps in alternative implementations. However, for many transactions, this may be impractical due to the fact that many credit or debit card transactions, for example, must be approved or denied immediately. Thus, certain preferred embodiments may be configured to approve or reject transaction requests based upon predefined rules/preferences, including user-defined rules and/or, in some cases, default rules created by the system, so that they can be approved or denied in real time, or within a few seconds of the request.

Returning to the beginning of sub-process 400, if a transaction or group of transactions has been identified as having been previously approved, the process may proceed to step 470, at which point a repeat transaction may be processed using a relatively smoother process. In some embodiments and implementations, this path may, for example, require less stringent data matches. For example, if a detailed transaction record is created and approved, such as one including a Merchant Category Code and/or other detailed information identifying the merchant and/or transaction, a match of such data may alone be used to authorize future transactions at step 480. However, various other types of data matching may be required at step 480 if desired, including any of those mentioned elsewhere in this disclosure.

If sufficient matching takes place, the transaction may be approved at 490 and the process may terminate and await future transactions. If the data fails the matching test, the process may proceed to step 460 and, in some implementations, may allow the user to correct/supplement to avoid future declining of the transaction, if desired. Alternatively, the process may terminate at this point.

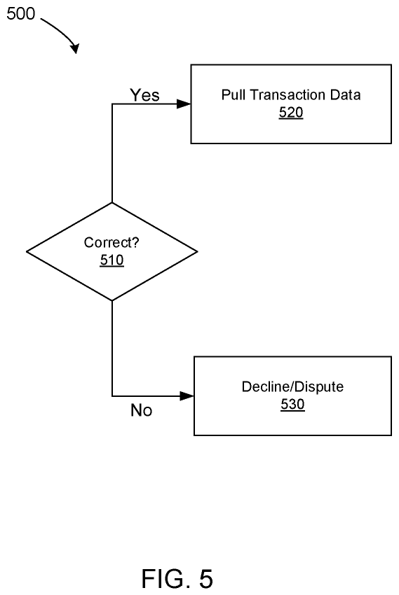

FIG. 5 illustrates an alternative structure for a portion of the processing of a first-time transaction, which may replace or supplement pertinent portions of sub-process 400 in some implementations. At step 510 of this alternative sub-process 500, a user may confirm whether a transaction that has already taken place, or a transaction that is being requested to take place, is sufficiently correct. If so, the transaction data from the approved transaction may be pulled by the system and saved for future use. For example, a merchant name and/or Merchant Category Code may be saved from the transaction to allow for simpler and/or quicker processing of the same or similar transactions in the future. Of course, any other data from an approved transaction, such as a pay date, pay amount, and the like, may be used to facilitate future matching if desired. The degree of matching required may be a preconfigured parameter of the system or, alternatively, may be based on user-defined rules/preferences, as mentioned above. For example, for monthly charges that are expected to be consistent in date and/or amount, less matching may be required than for transactions from merchants that vary widely in amount and/or timing.

If, on the other hand, the user disputes the transaction and/or at least a portion of the accuracy and/or rules of the transaction, alternative sub-process 500 may proceed to step 530, at which point the transaction may be declined or, if the transaction has already taken place, may be entered into a dispute process. The dispute process may be facilitated by the system, handled entirely by the system, or routed to a third-party, such as a credit card company or financial institution, in order to have the transaction investigated and potentially reversed.

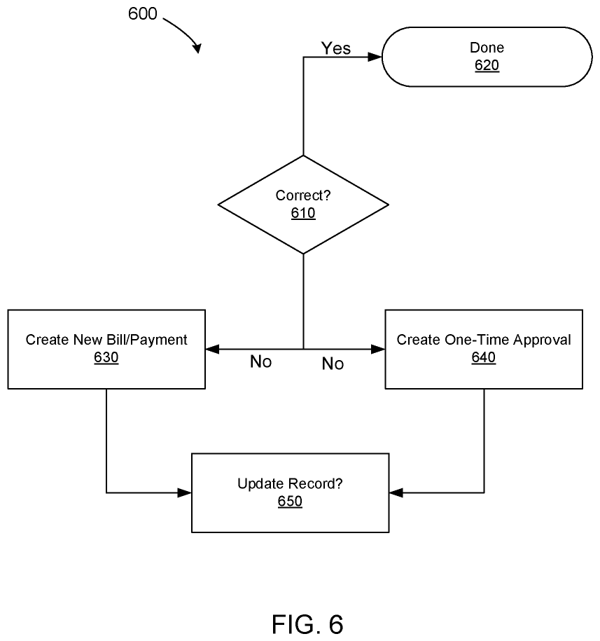

FIG. 6 illustrates an alternative structure for a portion of the processing of a repeat transaction, which may replace or supplement pertinent portions of sub-process 400 in some implementations. In particular, sub-process 600 may replace step 450 and subsequent steps in connection with a repeat transaction in some implementations. At step 610 of this alternative sub-process 600, a user may confirm whether the system correctly declined an incoming transaction that had been flagged as an anticipated repeat transaction.

If the user indicates that the transaction was correctly declined, the process may end at 620. If, on the other hand, the user indicates that the transaction was incorrectly declined at 610, the process may proceed to either step 630 or step 640 to allow the user to resolve the incorrectly denied transaction. At step 630, for example, the system may create and/or assist the user in creating a new bill and/or attempting payment of the original bill again. For example, if the original bill was declined because the user inadvertently created a payment amount or payment range that failed to match the original bill, the system may allow the user to update the rules to correct the error. As another example, the transaction may have been denied due to an insufficient match in the merchant information. Step 630 (or step 640, as discussed below) may then allow the user to input additional merchant details and/or loosen the matching restrictions.

Alternatively, the process may proceed to step 640, which may allow the user to create a one-time approval. This may allow the user to approve a transaction without requiring updating of rules or other data that may impact future transactions. For example, the user may recognize the transaction as one that should have been approved but may not want the hassle of entering additional data at the moment (in some cases, the user may update the rules/preferences/data at a later time). Thus, the user can authorize the denied transaction using the identical transaction data previously provided (which led to the inaccurate denial). In some cases, step 640 may require contacting the merchant so that the merchant can reissue the invoice/transaction. This may be done by the user manually or, alternatively, in some embodiments and implementations the system may be configured to automatically communicate with the vendor to request the reissuance of the same transaction.

The system may then update records at 650. This step may ask the user whether records should be updated, may automatically update records, or may be skipped. For example, if the user authorized a one-time approval at step 640, the system may ask the user whether future transactions of this type (either identical or sharing a predetermined number of parameters/data points) should be approved. In some cases, the system may automatically update user preferences or seek additional input or approval from user for such updates. For example, the if a new bill record is created at 630, the system may either automatically update user preferences to reduce the chances of the incorrectly rejected transaction being denied in the future or may seek additional input from the user to reduce this possibility.

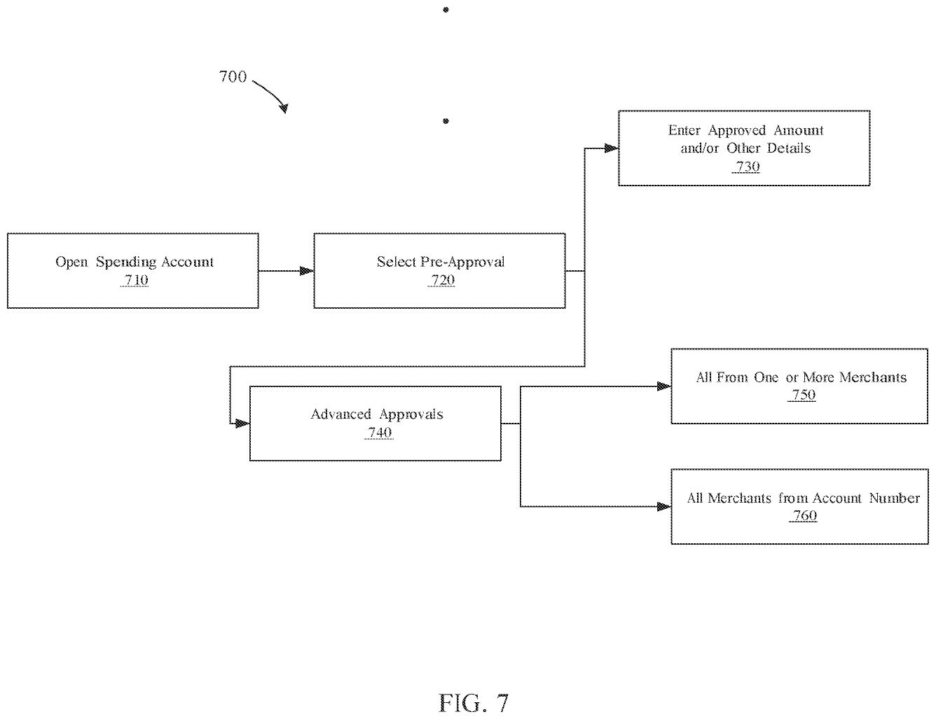

FIG. 7 illustrates a sub-process 700 that may be a part of method 400 or any other method disclosed herein in some implementations. For example, sub-process 700, or a portion thereof, may be used to provide the data matching in steps 430 and/or 490 in FIG. 4. Sub-process 700 may, in some implementations, begin with opening an account, which would typically be a sub-account and/or virtual account that will be used to track bills from a particular vendor or otherwise of a particular type (i.e., matching a predetermined number of rules set by the user and/or the system). For example, upon receiving an indication of an incoming transaction, depending upon how much time is allotted for accepting or declining the transaction, an account may be established automatically, or the user may be given the option to establish one. In the case of an automatically established account, following application of the data matching and/or acceptance or declining of the transaction, the user may be given the option to accept, reject, or modify the parameters of the account.

The user may then be given the option to select a pre-approval option for the account at 720. If the user desires to accept or reject each transaction attempt manually, the user may decline. If the user desires to proceed with pre-approval, the approved amount and/or any other details to allow the system to approve or reject a transaction may be entered at either 730 or 740.

If the user desires to establish rules for a series of advanced approvals at 740, this may be done by allowing all charges from a particular merchant or group of merchants at 750. The user may instead choose to allow all merchant charges from a particular account or virtual account at 760. For example, if a user wishes to establish a particular account number, which may have an associated card number for authorizing charges, that is free from authorization restrictions, the user may do so. Of course, the user may establish the account opened at 710, or any other account usable under the system, with any of the rules/restrictions described herein instead if desired.

In some implementations, step 760 may comprise opening a new virtual account, which may include in some cases issuance of a new virtual account number for payment of future transactions from a particular merchant or group of merchants. Thus, for example, a user may wish to provide advanced approvals for a group of several merchants in the category of “utilities,” as previously mentioned. Step 760 may therefore comprise pre-approving transactions from a set of pre-identified merchants along with opening a particular account, account number, sub account, sub account number, and/or the like for use in future transactions from these merchants. Additional rules for approval of such transactions may be provided or the user may simply wish to approve any and all from these merchants.

Step 750 may also, or alternatively, comprise locking and/or associating all future transactions from a particular merchant to a particular account, sub account, and/or virtual account within the system. For example, a user may decide to associate all future incoming transactions from an Internet provider to a bill payment account identified as “utilities.” These future transactions may also, but need not necessarily be, always allowed. In some cases, a user may wish to instead provide additional rules/restrictions for how/whether such transactions from the identified merchant are approved.

In some embodiments, a user may also, or alternatively, wish to automatically approve any and all transaction requests from a particular merchant that is particularly trusted. Thus, a user may decide to allow all incoming transactions from a particular merchant, or all incoming transactions from any merchants for a particular sub/virtual account, such as utilities, which may reduce problems associated with failed payment transactions for vital service providers, for example. A particular sub-account may simply be set up for “trusted” vendors/merchants, for example, which may allow all incoming transaction requests, possibly up to a predetermined threshold amount, to go through with this particular virtual/sub account number, which may have an associated debit card. In some embodiments, however, the user may only be issued a single debit card and payments may be processed within virtual/sub accounts according to other details of the proposed transactions, such as merchant names, transaction amounts, ranges, or thresholds, transaction dates or date ranges, etc.

As those of ordinary skill in the art will appreciate, steps 750 and 760 are just examples. Thus, a user may decide to accept all incoming transactions on a particular date, within a particular date range, below a particular amount, or any combination of the foregoing or any other desired bill payment authorization parameter. In addition, in some embodiments and implementations, a user may be able to select an option that requires explicit authorization for each transaction, which may come in the form of a notification from a mobile or web-based application, text message, email message, or the like. Similarly, some embodiments may be configured to, or allow a user to select an option to, automatically provide a notification for each rejected transaction, each accepted transaction, or both. In connection with such notifications, some embodiments may further allow the user to indicate with respect to each rejected and/or accepted transaction whether the transaction was properly accepted or rejected, which may allow the system to learn/improve over time to decrease incorrectly handled transactions.

As used herein, a software module or component may include any type of computer instruction or computer executable code located within a memory device and/or m-readable storage medium. A software module may, for instance, comprise one or more physical or logical blocks of computer instructions, which may be organized as a routine, program, object, component, data structure, etc., that perform one or more tasks or implements particular abstract data types.

In certain embodiments, a particular software module may comprise disparate instructions stored in different locations of a memory device, which together implement the described functionality of the module. Indeed, a module may comprise a single instruction or many instructions, and may be distributed over several different code segments, among different programs, and across several memory devices. Some embodiments may be practiced in a distributed computing environment where tasks are performed by a remote processing device linked through a communications network. In a distributed computing environment, software modules may be located in local and/or remote memory storage devices. In addition, data being tied or rendered together in a database record may be resident in the same memory device, or across several memory devices, and may be linked together in fields of a record in a database across a network.

Furthermore, embodiments and implementations of the inventions disclosed herein may include various steps, which may be embodied in machine-executable instructions to be executed by a general-purpose or special-purpose computer (or another electronic device). Alternatively, the steps may be performed by hardware components that include specific logic for performing the steps, or by a combination of hardware, software, and/or firmware.

Embodiments and/or implementations may also be provided as a computer program product including a machine-readable storage medium having stored instructions thereon that may be used to program a computer (or other electronic device) to perform processes described herein. The machine-readable storage medium may include, but is not limited to: hard drives, floppy diskettes, optical disks, CD-ROMs, DVD-ROMs, ROMs, RAMs, EPROMs, EEPROMs, magnetic or optical cards, solid-state memory devices, or other types of medium/machine-readable medium suitable for storing electronic instructions. Memory and/or datastores may also be provided, which may comprise, in some cases, non-transitory machine-readable storage media containing executable program instructions configured for execution by a processor, controller/control unit, or the like, of a computer or other computing device, such as a mobile smartphone.

The foregoing specification has been described with reference to various embodiments and implementations. However, one of ordinary skill in the art will appreciate that various modifications and changes can be made without departing from the scope of the present disclosure. For example, various operational steps, as well as components for carrying out operational steps, may be implemented in various ways depending upon the particular application or in consideration of any number of cost functions associated with the operation of the system. Accordingly, any one or more of the steps may be deleted, modified, or combined with other steps. Further, this disclosure is to be regarded in an illustrative rather than a restrictive sense, and all such modifications are intended to be included within the scope thereof. Likewise, benefits, other advantages, and solutions to problems have been described above with regard to various embodiments. However, benefits, advantages, solutions to problems, and any element(s) that may cause any benefit, advantage, or solution to occur or become more pronounced, are not to be construed as a critical, a required, or an essential feature or element.

Those having skill in the art will appreciate that many changes may be made to the details of the above-described embodiments without departing from the underlying principles of the invention. The scope of the present inventions should, therefore, be determined only by the following claims.

1. A method for automated bill payment, the method comprising the steps of:
receiving bill data regarding a first user of a bill payment system, wherein the bill data is at least one of entered on a mobile application or a web-based application under control of the first user and received from a merchant of the first user, and wherein the bill data comprises at least sufficient data to identify an anticipated bill;
creating a bill authorization data record from the bill data, wherein the bill authorization data record contains data sufficient to accept or reject requested transactions;
receiving a transaction attempt from a merchant comprising at least one of a requested ACH transfer and a requested debit card transaction;
comparing data from the transaction attempt with data from the bill authorization data record;
accepting or rejecting the transaction attempt based upon the comparison of data from the transaction attempt with data from the bill authorization data record; and
upon determining that transaction attempt should be accepted, automatically transferring funds from an account of the first user in the bill payment system to complete a transaction requested in the transaction attempt.

2. The method of claim 1, wherein the bill data comprises merchant identifying information.

3. The method of claim 2, wherein the bill data further comprises at least one of an authorized transaction amount and an authorized transaction amount range.

4. The method of claim 3, wherein the bill data further comprises at least one of an authorized date and an authorized date range.

5. The method of claim 1, further comprising receiving bill data for each of a plurality of accounts, wherein each of the plurality of accounts is associated with a distinct merchant.

6. The method of claim 1, further comprising declining any and all transaction attempts that fail to match preconfigured parameters established within a bill authorization data record.

7. The method of claim 1, further comprising receiving an outgoing bill payment request to transfer funds from the first user of the bill payment system to a second user of the bill payment system, wherein the outgoing bill payment request comprises an amount and a recurring time period for automated, repeated payment of the amount.

8. The method of claim 1, further comprising:
receiving an indication from the user as to whether the transaction attempt was properly accepted or rejected and, upon receiving an indication from the user that the transaction attempt was properly accepted, saving merchant identification data associated with the accepted transaction; and
using the merchant identification data to facilitate expedited authorization of a subsequent transaction from the same merchant.

9. The method of claim 1, receiving a transaction attempt from a second merchant comprising a requested ACH transfer and receiving a transaction attempt from a third merchant comprising a requested debit card transaction.

10. A method for automated bill payment, the method comprising the steps of:
receiving a set of bill payment rules from a first user of a bill payment system from a mobile application or a web-based application under control of the first user;
receiving a first bill payment request from a first merchant for payment of a first bill by the first user, wherein the first bill payment request comprises an ACH transfer request;
comparing data from the first bill payment request with the set of bill payment rules;
selectively accepting or rejecting the first bill payment request according to whether the first bill payment request contains data matching parameters established by the set of bill payment rules;
receiving a second bill payment request from a second merchant for payment of a second bill by the first user, wherein the second bill payment request comprises a requested debit card transaction;
comparing data from the second bill payment request with the set of bill payment rules; and
selectively accepting or rejecting the second bill payment request according to whether the second bill payment request contains data matching parameters established by the set of bill payment rules.

11. The method of claim 10, further comprising, upon accepting the first bill payment request, saving data from the first bill payment request and linking the saved data from the first bill payment request with an account of the first user.

12. The method of claim 11, further comprising:
receiving a third bill payment request from the first merchant for payment of a third bill by the first user; and
accessing the saved data from the first bill payment request to facilitate faster approval of the third bill payment request.

13. The method of claim 10, wherein the set of bill payment rules comprises at least one of a merchant name, a merchant ID number, a transaction amount, a transaction amount range, a transaction amount threshold, a transaction date, and a transaction date range.

14. The method of claim 10, wherein a separate set of bill payment rules is established for each sub-account of a plurality of sub-accounts of the first user.

15. The method of claim 10, further comprising:
upon determining that the first bill payment request should be rejected, sending an inquiry to the first user regarding whether the rejection of the first bill payment request was handled properly;
receiving a response from the first user to the inquiry; and
upon receiving a response to the inquiry that the first bill payment was handled incorrectly, updating the set of bill payment rules in a manner such that future bill payment requests matching the first bill payment request will be accepted.

16. A system for automated bill payment, comprising:
one or more processors;
a computer readable memory operably coupled with the one or more processors;
a bill payment rules module configured to receive bill authorization data from at least one of a mobile application or a web-based application under control of a first user of the system for automated bill payment and a merchant requesting payment of a bill by the first user; and
a bill payment authorization module configured to receive a bill payment request from a merchant for payment of a bill by the first user, wherein the bill payment authorization module is configured to compare data acquired by the bill payment rules module with data from the bill payment request to selectively approve or deny the bill payment request.

17. The system of claim 16, wherein the system is configured to receive and selectively accept or reject bill payment requests as either ACH transfer requests or debit card transaction requests.

18. The system of claim 16, wherein the bill payment rules module is configured to establish and link a separate set of rules with each of a plurality of sub-accounts associated with the first user.

19. The system of claim 16, wherein the system is configured to compare incoming bill payment requests with data associated with previous transactions associated with the first user and revise further processing of incoming bill payment requests depending upon whether a match with a previous transaction associated with the first user is identified.

20. The system of claim 19, wherein the system is configured to, upon determining that a merchant associated with an incoming bill payment request fails to sufficiently match a previous transaction, and following approval of the incoming bill payment request, send an inquiry to a user to confirm whether the approval was handled appropriately and, upon confirmation that the approval was handled appropriately, save transaction data from the incoming bill payment request to be used to streamline future processing of bill payment requests from the same merchant.
